(19) United States
(12) Patent Application Publication
(10) Pub. No.: US 2008/0087181 A1
(43) Pub. Date: Apr. 17, 2008

(54) METHOD FOR PRODUCING A FLEXO PLATE MOLD

(76) Inventors: Tal Goichman, Kiriat Ono (IL); Alexander Veis, Kadima (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 11/778,089

(22) Filed: Jul. 16, 2007

Related U.S. Application Data
(60) Provisional application No. 60/852,129, filed on Oct. 17, 2006.

(51) Int. Cl. B41C 3/00

(52) U.S. Cl. 101/401.1

(57) ABSTRACT

A method is provided to produce a mold for casting in and curing of a curable material for flexo plate production, the method comprising the steps of: providing a substrate having at least one of a layer of ablative material and a supporting layer of non-ablative material; selectively performing at least one of laser ablation on the layer of ablative material and additively building up an image relief on non-ablated areas to produce the mold; filling the mold with a curable material; curing the curable material to form a flexo-plate; and then removing the flexo-plate from the mold.

### FIELD OF THE INVENTION

The present invention generally relates to the field of flexography printing, and more particularly, to a method for producing a negative relief mold for flexo plate printing.

### BACKGROUND OF THE INVENTION

Flexography is the major process used to print packaging materials. This process is used to print on corrugated and folding cartons, multi-wall sacks, paper sacks, plastic bags, milk and beverage cartons, disposable cups and containers, labels, adhesive tapes, envelopes, newspapers. The imprint is done by using flexographic (hereinafter, flexo) plates which have an imaged relief with bumps in the printing area.

### Conventional Digital Flexo

Conventional digital flexo plates usually comprise a base and a photopolymer layer which is cured by UV light. The UV light is projected via an image mask (film or “on plate” directly ablated layer). Then, the uncured material is removed by solvents or water and soap, and mechanical brushes. Since this is a long, costly and chemically unclean process, many attempts to develop a chemicals free process were made.

### Direct Imaging Flexo

One of the possible solutions to avoid chemical processors is the process of direct imaging flexo.

A blank flexo plate is imaged by utilizing a high power laser to produce the needed valleys according to screened data. There are several problems related to this approach:

The plate material must have several contradictory properties. It must have the mechanical strength and flexibility to survive the printing process, but it must be easily ablated by laser. The material must absorb IR (or other) radiation and must have ink wetting properties, chemical resistance, resilience and more.

The laser power must be very high, greater than 1 kW, in order to produce the plate in a reasonable time. The amount of material that must be ablated for each flexo plate can reach kilograms per square meter. This generates large quantities of fumes and particles that can reduce the image quality and pollute the environment. Approximately one kilogram of polymer turns into smoke by direct flexo imaging.

There is a built-in imaging problem with this process. The problem comes from the fact that ablation should be performed down to 800 microns and more. Laser beam depth of focus and numerical aperture allow for good resolution only on the focus level. When the laser beam reaches the deepest, non-printing layers, the surface layers are exposed to a defocused spot that can be many times bigger than the focused spot. To develop such a complicated material and imaging system could be very costly and time consuming. More than that, the system will be expensive to maintain and slow to operate, while requiring very expensive consumables.

### Thermal Processing Flexo

Another approach which tries to address the problem of the above-mentioned chemicals and fumes is the Cyrel Fast plate by DuPont. In this approach, the plate is imaged like a regular flexo plate, but the after-processing requires use of heat to “tear out” the unexposed pieces of plate to create valleys. Although the process is cleaner than the conventional plate production, the media and device costs are very high and do not allow turning it into a widely used process. Furthermore, the process yields much less durable results than conventional plates in terms of number of print runs and image stability.

Flexographic plate production by casting and curing liquid polymer into a negative relief mold has never been widely commercialized, although patents describing this approach go back to the 1960's. For example:

U.S. Pat. No. 3,470,059 to Nelson Jonnes posits a matrix for molding a positive relief impression.

U.S. Pat. No. 7,074,358 to Alexander S. Gybin et. al. describes a polymer casting method and apparatus using a stereo lithography/photochemical process which produces a mold, but needs washing and produces low-resolution images.

These prior art patents generally relate to producing a negative relief to produce a positive relief flexographic plate, yet they do not provide solutions for the most acute process problems:

a) liquid processing and handling and disposing of washout chemicals;

b) resolution required for process color—at least 150 lpi, required spot size of less than 100 microns;

c) multi-resolution levels required for shouldered or conical 3D shape of each pixel;

d) printing surface planarity—the bumps should be on the same level, otherwise some of them will not contact the printed media; and

e) high cost of materials and devices to implement the solution.

Thus there is a need to provide a flexo plate-making method which will dispense with the need for the use of cleaning chemicals and solvents, meet the requirements for color resolution and multi-resolution levels, maintain printing surface planarity, and be inexpensive to implement.

### SUMMARY OF THE INVENTION

Accordingly, it is a broad object of the present invention to overcome the above-mentioned drawbacks of the prior art and provide a method for producing a negative relief mold for use with a flexo plate which utilizes a process of creation for casting in curable material, such as liquid, particle, and powder forms of polymer or photopolymer resin.

Another object of the invention is to minimize cost and maximize productivity of mold material while optimizing the mold production process regardless of flexo plate properties.

It is another object of the present invention to utilize off-the-shelf flexo plate curable materials—such as liquid, solid particles, and powder forms—of polymer resins and the like, without the need for expensive and time-consuming development.

It is yet another object of the present invention to provide mold material which can be recyclable within a plant and partially reused, thus reducing the cost of ownership for printers.

It is still another object of the present invention to provide a mold process which eliminates the need for etching chemicals, and the handling and removal of toxic wastes.

It is a further object of the present invention to ensure that flexo plate printing bumps will be at the same planar level by starting the mold relief creation (additive or subtractive) from a flat plate.

It is yet another object of the present invention to provide a method of making a flexo plate mold by combining fine resolution laser ablation with coarse machining to form shoulders in additive and subtractive build up procedures.

Therefore there is provided a method to produce a mold for casting in and curing of a curable material for flexo plate production, the method comprising the steps of:

providing a substrate having at least one layer of ablative material and a supporting layer of non-ablative material;

selectively performing at least one of laser ablation on the layer of ablative material and additive building up image reliefs on non-ablated areas to produce the mold;

filling the mold with a curable material;

curing the curable material to form a flexo-plate; and

removing the flexo-plate from the mold.

The basic flexo 3D image structure has a shouldered or conical shape. To produce such a relief by casting, a negative relief mold is produced. The required flexo plate relief is usually hundreds of microns deep (normally between 300 to 800 microns) to make sure only the printing surfaces make contact with the media. To support small image dots, the structure is conical, starting with actual dot-size print and tapering out to prevent buckling. Thus, the mold negative relief should be negatively conical as well. The bottom layer of the mold representing the print level of the flexo plate must have the highest resolution with dots size of at least 100 microns.

The farther from the print layer, the less important is the factor of the resolution of the relief. In fact, after a few tens of microns from the print level, the main purpose of the relief is to provide for support. This means that the image layers can be divided into fine and coarse layers. The fine layers require high resolution and a low depth of several tens of microns. The coarse layers do not have to be produced with high-resolution imaging, but need to have a relief of hundreds of microns. These facts produce an opportunity for process and materials optimization to achieve a combination of high resolution and high throughput methods. Each layer can be produced by one or more imaging methods, depending on desired resolution and throughput.

Both coarse and fine layers are produced in either additive or subtractive techniques or their combination. The sequence for creation of coarse and fine layers is not confined to a particular recipe as long as the images are adapted at each layer to create a suitable coverage that eventually produces a shouldered profile.

Furthermore, the method of the present invention allows freedom of choice of mold producing technologies such as IR lasers, inkjet heads, solid particles combined with liquid phase, and others as are known to those skilled in the art.

The methods of negative relief creation for molds are based on laser imaging techniques, as well as other 3D manufacturing concepts as is known to those skilled in the art. The flexographic plate material and printing qualities are totally independent of mold imaging techniques. The liquid resin completely fills the mold relief and, after curing, produces an opposite to the mold relief In a preferred embodiment of the present invention, the mold has durability which allows for several liquid polymer casting and curing cycles.

The present invention allows producing a high-resolution flexo plate by bypassing the contradictory requirements of easy imaging vs. good printing qualities.

Once the resin is cured it obtains all the printing properties of a flexo plate. The mold material is optimized for the fastest and easiest imaging, while the flexo resin properties are optimized for printing.

Thus, separating the imaging and the printing media creates an economical and multi-optional process which is clean, free of etching chemicals, and which does away with the need for scrubbing brushes. The cost of materials, including the cost of liquid polymers, is low because of the low mechanical requirements demanded from the mold material.

Principal advantages of the method of the present invention are the possible optimization of mold materials and relief creation techniques for best resolution, total elimination of washout chemicals, throughput enhancement and cost reduction. It should be noted that this is achieved by the fact that all the processes described for the present invention are used for mold rather than for plate creation, The mold does not have to be flexible and durable for multi-run printing. All the preferred techniques are dry and do not require washouts.

Other features and advantages of the invention will become apparent from the following drawings and descriptions.

### BRIEF DESCRIPTION OF THE DRAWINGS

For a better understanding of the invention with regard to the embodiments thereof, reference is made to the accompanying drawings, in which like numerals designate corresponding elements or sections throughout and wherein:

FIG. 1 illustrates a laser ablation subtractive method in accordance with a preferred embodiment of the present invention;

FIG. 2 shows another embodiment of the method of the present invention using a multi-focusing technique for laser ablation on a single substrate;

FIGS. 3a, 3b, 3c illustrate a general process for the production of a negative mold relief and a positive flexo plate in a preferred embodiment of the present invention;

FIGS. 4a and 4b illustrate the use of machining the bulk relief at a course layer prior to laser imaging at a finer layer;

FIG. 5 illustrates another embodiment of the method of the present invention;

FIG. 6 shows an inkjet method of building the relief;

FIG. 7 shows an alternate method of the present invention comprising heating by laser of solid particles, melting a bonding media, and suctioning off unwanted material; and

FIG. 8 illustrates yet another embodiment of the present invention utilizing ink jet technology.

### DETAILED DESCRIPTION OF THE INVENTION

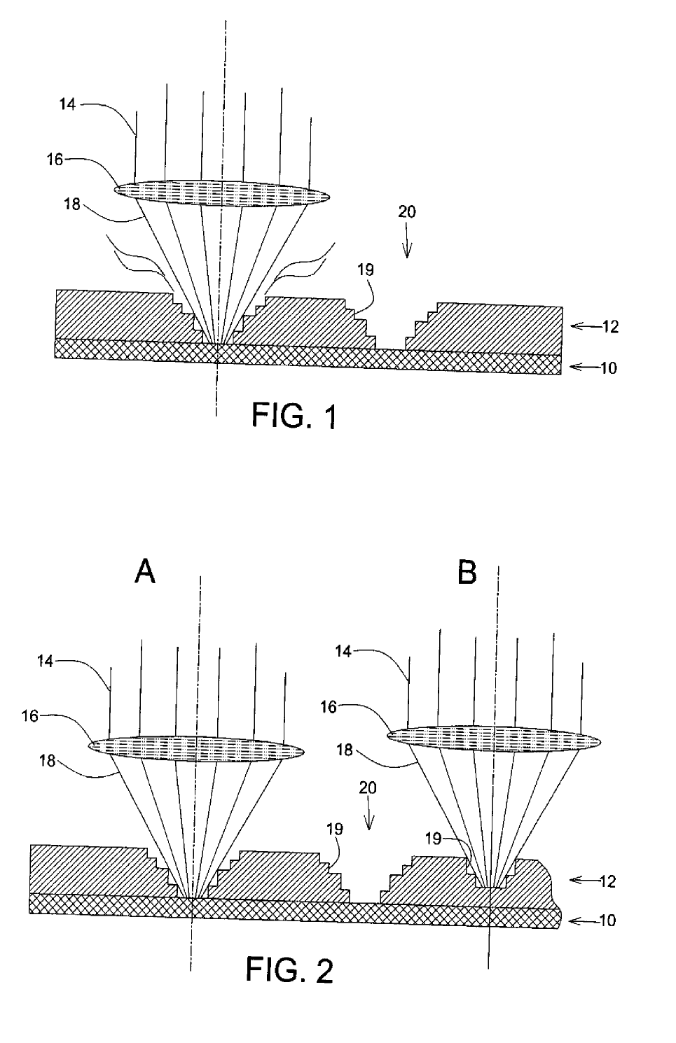

FIG. 1 illustrates a laser ablation subtractive method in accordance with a preferred embodiment of the present invention.

A laser beam 14 is passed through a focusing lens 16 to form a convergence cone 18 which is focused on the final depth of an ablative polymer material 12 to the non-ablative level, that is, at the upper surface of a non-ablative substrate 10. Substrate 10 is made of a plate of thin aluminum or any other non-ablative material as is known to those skilled in the art. The convergence cone 18 produces natural shoulder reliefs 19 in the inverse cone 20 formed in the curative material 12, such as ablative, liquid polymer material.

FIG. 2 shows another embodiment of the method of the present invention using a multi-focusing technique for laser ablation on a single substrate.

The method utilizes multi-focusing on the bottom of each ablatable layer. Laser beam 14 is passed through focusing lens 16 to form convergence cone 18. In technique A shown performed on one side of FIG. 2, convergence cone 18 from laser beam 14 is focused on the deepest layer within curable material 12 up to the non-ablatable substrate 10.

In technique B shown on the other side of FIG. 2, convergence cone 18 is shown focused to a shorter depth within curable material 12 at the level of shoulder reliefs 19 forming the inverse cone 20. This multi-focusing allows high resolution which is compensated for upon imaging. Each digitally imaged layer is designed to produce a conical cross-section.

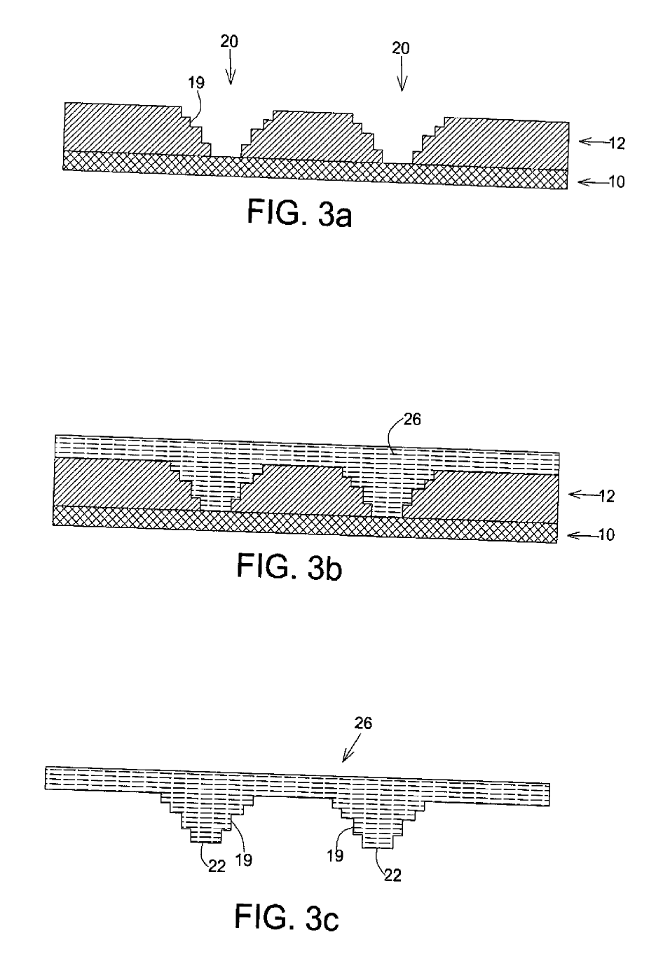

FIGS. 3a, 3b, 3c illustrate a general process for the production of a negative mold relief and a positive flexo plate in a preferred embodiment of the present invention.

A mold is provided as shown in FIG. 3a. It is filled in with curable material 26, such as a liquid polymer resin, as shown in FIG. 3b. Curable material 26 is then removed so as to yield a negative relief flexo plate as shown in FIG. 3c. A high-resolution image is created by pouring curable material 26, such as UV liquid polymer material in a preferred embodiment of the present invention, into the mold and curing it by UV light.

In FIG. 3b, curable material 26 is shown to completely fill in the shoulder relief of inverse cone 20. When curable material 26 is cured and hardened, it is separated from the lower layers of material and, as shown in FIG. 3c, comprises a reusable flexo plate having planar printing surfaces 22 supported by shoulder reliefs 19.

To obtain different physical properties, such as hardness or resiliency, of the final plate, resin can optionally be filled layer by layer and different curing regimes applied. For example, a thin, low viscosity printing layer can be poured onto the mold relief. Low viscosity and thin layer will ensure good pits filling, preventing air bubbles. After that, a higher viscosity resin can be poured in without a risk of air bubbles forming to affect the printing quality. Finally, still another, backing resin can be added to fill in the mold to provide toughness to the flexo plate.

The same mold can be used for more than one flexo plate casting, provided the mold is made of durable material. Cured resin removal does not require any pattern breakages as the bumps profile will always be of conical or stepped shape that allows mold-flexo separation without undercuts.

Resin curing can be done in any technique as is known to those skilled in the art, such as UV curing. There are other non-UV curable materials in which the reaction is initiated by heat or humidity. In accordance with the principles of the present invention, a preferred method involves the use of UV curable liquid resins.

For subtractive laser imaging, a thin aluminum sheet, a few tenths of a millimeter thick, surface treated by black sulfuric anodization, is plated with a polymer containing black carbon additives for radiation absorption, 0.5-1.0 mm thick and nitrocellulose for enhanced laser ablation characteristics. The anodized aluminum serves as the fine layer media, whereas the polymer serves as the coarse layer media. The prefabricated sandwich is placed in a laser image setter device (not shown). The layers are laser ablated and imaged by one or more passes, depending on the power density applied to the mold, for creating negative reliefs with shoulders into which curable material 26 can be cast (see FIG. 3b) and cured to produce a flexo mold with negative raised images.

To ensure that the bottom, printing level will have the same relief depth, the ablation is done until the black, anodized layer is removed by laser beam 11 passed through focusing lens 16 to form convergence cone 18. The final focus level should be approximately on the bottom of the anodized layer. For the non-printing layers, the focus position can be either on the corresponding ablation layer or the final print layer. In either case, the printing layer resolution will not be damaged by a defocused beam. The focused beam diameter is the smallest of all, thus providing for the best printing humps resolution. To further ensure the quality of the mold printing layer and optimize the throughput of the coarse layers, the reliefs can be imaged with power modulation as a function of screen density. The higher the laser power is, the larger the spots that will be produced due to the media non-linearity response.

To further enhance the throughput of material removal in the coarse mold layers, the material used, in a preferred embodiment of the present invention, consists of porous, foam-like media with additives of black carbon for improved radiation absorption, and some nitrocellulose that magnifies laser power. The major advantage of this method over direct flexo engraving is that the ablated mold materials need not have expensive and high quality mechanical properties: need not have flexibility for prints, nor stress durability. These low-level demands allow a drastic reduction in laser power and a reduction of fumes, allowing use of lower-cost, non-functional materials and, most importantly, achieve superior image quality.

The ceramic quality of the black sulfuric anodization layer provides for sharp image boundaries, impossible to achieve by either direct flexo engraving or photochemical flexo etching process as in the prior art.

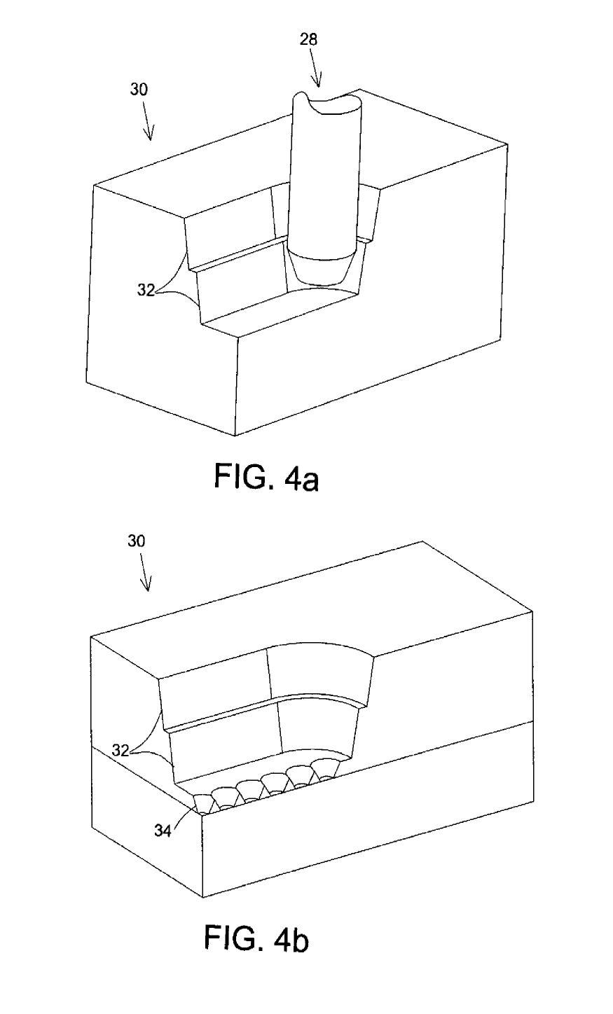

FIGS. 4a and 4b illustrate the use of machining to remove the bulk reliefs prior to laser imaging. Large mold areas that do not require high resolution can be produced by machining. Throughput vs. resolution is traded off by removing the hard mold media with a milling head having several cutting tools 28 of various diameters. The machined areas can then be inkjet or laser imaged for producing negative reliefs of printing quality.

In FIG. 4a, a milling tool 28 (represented by a partial view of a milling head) is used to machine coarse layers 32 in a machinable polymer of layer 30 to form conical, shouldered reliefs far away from the reliefs in the imaging areas.

In FIG. 4b, a lower, fine layer 34 has been ablated by using a laser beam (not shown). This method uses a combination machining for the coarse layer and laser ablation for the fine layer. Each mold pixel is imaged in a “shouldered” or pyramidal profile, starting from the wide base and going down to the final pixel dimensions. In fact, it is an upside down pyramid, allowing production of non-imaging layers by a low resolution process (e.g., machining) and then finally producing “imaging” high resolution layers (e.g., by laser).

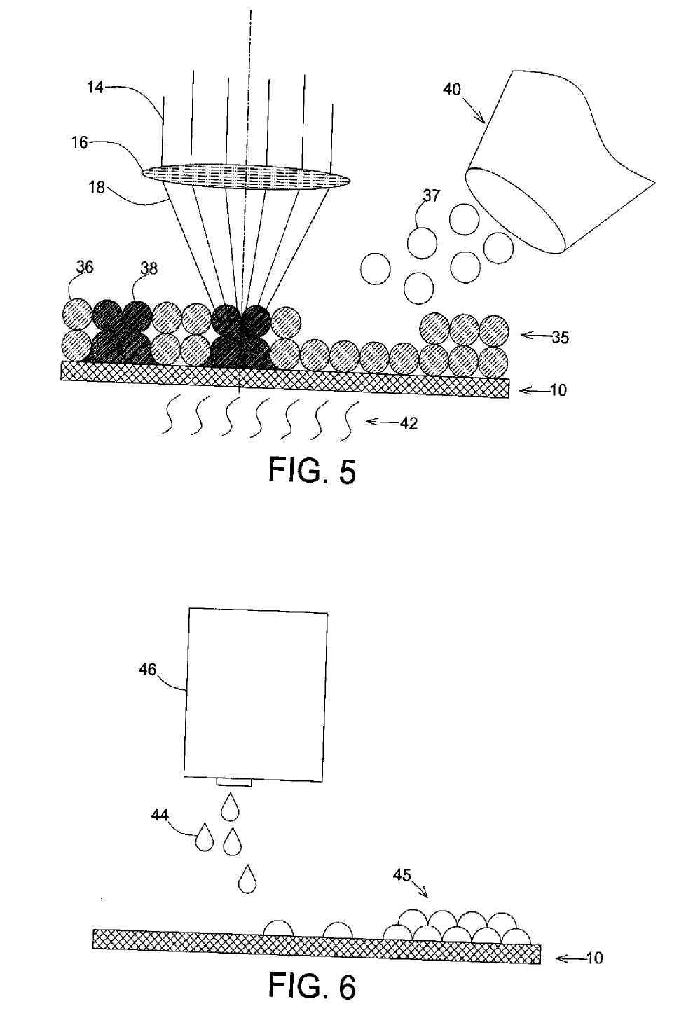

FIG. 5 illustrates spreading polymer powder and selective laser fusing the polymer powder.

Layers 35 of a polymer powder 36 are spread over a non-ablative substrate 10, such as aluminum. Heat 42 is applied to the substrate 10 to raise the temperature of polymer powder 36 to reduce the amount of power required from convergence cone 18. A laser beam 14 is passed through a laser focusing lens 16 to form convergence cone 18 used to selectively fuse the melted polymer material 38 which then forms cured printing areas (shown by darker fused particles). Residues of unfused powder particles 37 are removed, for example, by being suctioned off by a suction device 40.

The disposable recyclable mold media—the media consisting of melted media and solid particles can be re-melted and re-circulated after producing the flexo plate. This feature can reduce user's costs and allow a clean process. In addition to that, the “suction” particles and melted material can also be reused.

The melted polymer material 38 which forms the mold media does not have to be homogenous—it can contain solid, non-melting, particles of sub-pixel size (e.g., black, light-absorbing particles) bonded together by easily melted media, such as ice or wax. When such a particle gets energy from laser beam, it heats up and liquefies the bonding media. Vacuum suction force applied in a vicinity of heated particles will lift the unattached particles and leave the bonded ones inside the mold.

FIG. 6 shows an inkjet method of building the relief in accordance with another embodiment of the present invention.

Referring now to FIG. 6, there is shown another additive method of coarse layer production using inkjet deposition and building curing layers. The droplets 44, e.g., inkjet, or wax, are produced and controlled via an inkjet device 46 and deposited on a non-ablative substrate 10, such as aluminum, to form thin layers 45 of droplets 44. The droplets 44 in layer 45 are then solidified, or they can be thermally cured. Stray spray droplets 44 of the inkjet can be ablated by applying a fine laser beam (not shown) to them.

Since a high-resolution image is not needed, drop placement accuracy of >10 microns can be achieved by using, for example, Spectra/Dimatix (www.dimatix.com) Nova or Galaxy ink jet printing heads. To create layer 45 to dimensions of 0.6 mm high and one square meter will take less than ten minutes while using only three suggested printing heads.

The ink used for build up can be a melted wax or any other rapid prototyping material as is known to those skilled in the art. There is also an option of ink-jetting liquid droplets 44 and freezing them down on the image surface to create the relief. The flexo “shoulders” are built using an algorithm developed for this purpose as is known to those skilled in the art.

Of course the mold preparation process can be done in reverse order, i.e., first a lower resolution relief is produced by ink-jetting, then fine details are added by laser engraving. In this case the laser beam ablates both mold layer and some parts of the inkjet relief (the part which covers the image area).

When using inkjet to produce an imaged mold, high-resolution border walls can be built using small nozzle heads and then filled in by using larger nozzle heads with much higher throughput (a combination of throughput and high resolution).

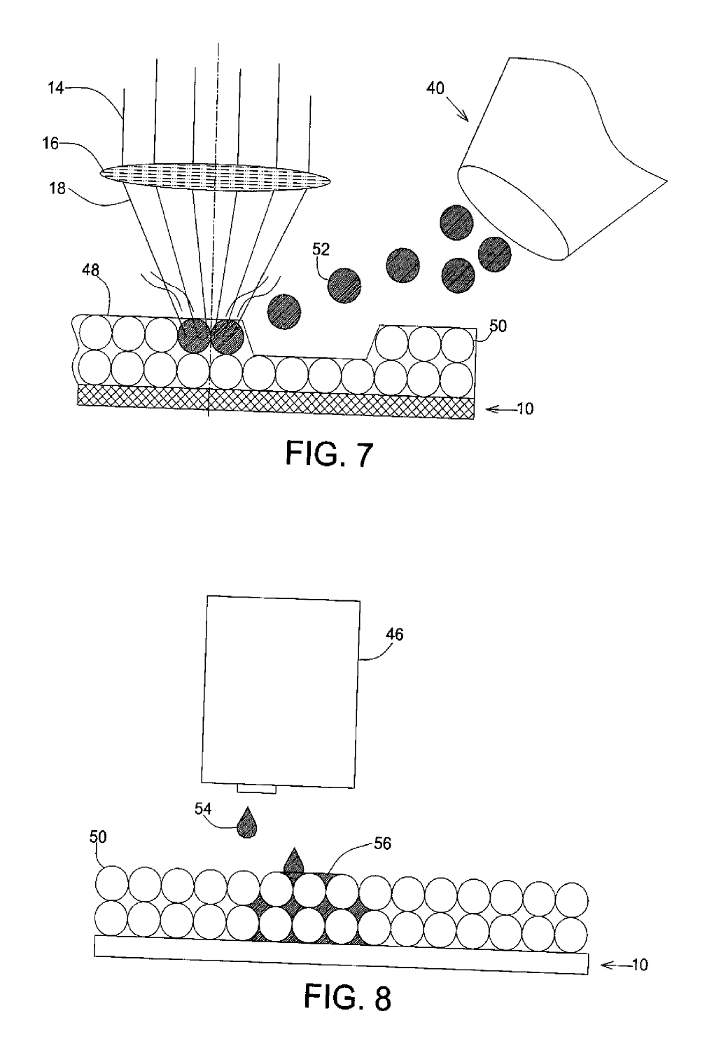

FIG. 7 shows another embodiment of the present invention. In this subtraction method of coarse layer creation, solid particles 50 are frozen in a bonding media 48. A laser beam 14 is passed through a focusing lens 16 to form a convergence cone 18 used to melt bonding media 48 by direct heating. Free particles 52 are torn out by suction device 40 to produce a desired coarse layer of bonded particles in bonding media 48.

The heated, unattached particles can optionally be removed by using electrostatic forces. In an alternative embodiment of the present invention, suction device 40 is electrostatic. By charging bonding media 48 and an electrostatic suction device 40 with opposite electric charges, an electrostatic force will be applied to all the solid particles 50 in the vicinity of suction device 40. Only those that were heated and melted by bonding media 48 will be released and will be pulled out of the mold, creating voids.

Alternatively, substrate 10 is coated with a physical mixture of easily melted bonder 48, e.g., wax, containing solid particles 50 used as a filler. Solid particles 50 are not intended to melt, but rather to heat as a result of laser beam 14 heating. The heating melts the bonding media 48 around solid particles 50 so the freed particles 52 can be easily removed with suction, thus creating a relief. The solid particles 50 can be made of plastic, ceramic or metallic materials. The main advantage of this method is low power required to melt wax and no burning products. The filler material, such as solid particles 50, is optimized for the lowest thermal capacity and for the lowest thermal conductivity for cross-talk prevention.

Variable resolution particles can also be used. Only the final, fine resolution should be at the bottom side of the mold. Thus the mold can be made of several layers of filler particles, each layer having particles of different sizes. This may be useful for throughput enhancement.

FIG. 8 illustrates another embodiment of the present invention. In this additive method, coarse layers are produced by spreading layers of a powder 36 onto a non-ablative substrate 10, such as aluminum, and then using an ink-jet device 46 to ink-jet a binder 54 which is injected into the image areas. The liquid, ink-jet binder 54 is cured or solidified by any method known to those skilled in the art, and the resultant mass 56 defines the solid areas. The unwanted, non-imaged areas are removed by a suction device 40 (see FIG. 7) to produce mold cavities. This process requires no laser ablation for creation of coarse layers.

Optionally, the image is ink-jetted onto the base level and powder 36 is spread onto the surface which is previously wetted.

Alternatively, a mixed method of laser melting/ablating and inkjet printing can be used (see FIGS. 1 and 6, respectively). The finest resolution layer is the bottom layer that eventually will be the contact between the flexo sheet and the paper, cardboard, or any other printable media. The required resolution in this 20-50 micron thick layer is 10-30 microns. Other layers are “relief” areas that are not intended to be printing surfaces and therefore can be produced by the hereinbefore described subtractive, heating and removal method. The next layers can be additively built up by injecting liquid droplets 44 (see FIG. 6) from an inkjet head 46 and immediately solidifying them either by cooling them to a solid state or UV curing them to achieve the same effect.

Having described the present invention with regard to certain specific embodiments thereof, it is to be understood that the description is not meant as a limitation, since further modifications may now become apparent to those skilled in the art, and it is intended to cover such modifications as fall within the scope of the appended claims.

We claim:

1. A method to produce a mold for casting in and curing of a curable material for flexo plate production, said method comprising the steps of:
providing a substrate having at least one of a layer of ablative material and a supporting layer of non-ablative material;
selectively performing at least one of laser ablation on said layer of ablative material and additively building up an image relief on non-ablated areas to produce said mold;
filling said mold with a curable material;
curing said curable material to form a flexo-plate; and
removing said flexo-plate from said mold.

2. The method of claim 1 further comprising:
preparing a set of digitally imaged layers for formation of shoulder reliefs using laser ablation.

3. The method of claim 1 further comprising:
preparing a set of digitally imaged layers for formation of shoulder reliefs using additive build up imaging.

4. The method of claim 2 wherein said shoulder reliefs are formed by a laser convergence cone.

5. The method of claim 1 wherein said mold is produced using at least one subtractive process selected from the list: laser engraving; machining coarse/bulk layers; selectively heating and suctioning particles for removal from a bonding media; and any combination of said at least one subtractive process.

6. The method of claim 1 wherein said mold is formed from more than one ablative layer comprising a multi-layered mold.

7. The method of claim 6 wherein said multi-layered mold comprises an aluminum layer overlaid with a black oxidized layer, and a laser absorbent layer comprising a polymer material.

8. The method of claim 6 wherein said multi-layered mold comprises an aluminum layer overlaid with a black oxidized layer covered by a layer of laser absorbent material comprising nitrocellulose.

9. The method of claim 6 wherein said multi-layered mold comprises an aluminum layer overlaid with a black oxidized layer covered by a layer of laser absorbent material comprising carbon black.

10. The method of claim 6 wherein said multi-layered mold further comprises foams provided with laser absorbents and active materials.

11. The method of claim 10 wherein said active materials comprise nitrocellulose.

12. The method of claim 1 wherein said mold is formed as a selective removal sandwich.

13. The method of claim 12 wherein said selective removal sandwich comprises a physical mixture of easily melting media having small particles.

14. The method of claim 12 wherein said physical mixture comprises at least one of wax, ice, and gel.

15. The method of claim 12 wherein said small particles are characterized as having good laser absorption.

16. The method of claim 1 wherein said building up image reliefs comprises building up layers comprised of inkjet drops.

17. The method of claim 1 wherein said building up an image relief comprises selective laser fusing of particles.

18. The method of claim 1 wherein said building up an image relief comprises spreading powder, and ink-jetting an imaging bonding agent.

19. The method of claim 1 wherein said mold is produced by adding carbon black additives to increase radiation absorption.

20. The method of claim 1 wherein said curable material comprises at least one of a polymer resin, photopolymer and a thermally-curable material.

21. The method of claim 1 wherein said curing is by at least one of UV illumination thermal heating, evaporation, and chemical crosslinking.
